(19) United States
(12) Patent Application Publication
(10) Pub. No.: US 2003/0039262 A1
(43) Pub. Date: Feb. 27, 2003

(54) Hierarchical mux based integrated circuit interconnect architecture for scalability and automatic generation

(75) Inventors: Dale Wong, San Francisco, CA (US); John D. Tobey, San Jose, CA (US)

Correspondence Address: GARY T. AKA, 12930 SARATOGA AVENUE, SUITE D1, SARATOGA, CA, 95070, US

(73) Assignee: Leopard Logic Inc., Cupertino, CA

(21) Appl. No.: 10/202,397

(22) Filed: Jul. 24, 2002

Related U.S. Application Data
(60) Provisional application No. 60/307,534, filed on Jul. 24, 2001.

(51) Int. Cl. H04L 12/28

(52) U.S. Cl. 370/419; 370/537

(57) ABSTRACT

This invention consists of a hierarchical multiplexer-based interconnect architecture and is applicable to Field Programmable Gate Arrays, multi-processors, and other applications that require configurable interconnect networks. In place of traditional pass transistors or gates, multiplexers are used and the interconnect architecture is based upon hiearchical interconnection units. Bounded and predictable routing delays, compact configuration memory requirements, non-destructive operation in noisy environments, uniform building blocks and connections for automatic generation, scalability to thousands of interconnected elements, and high routability even under high resource utilization are obtained.

### CROSS-REFERENCES TO RELATED APPLICATIONS

This patent application claims priority from U.S. Provisional Patent Application No. 60/307,534, filed Jul. 24, 2001, which hereby is incorporated by reference in its entirety.

### BACKGROUND OF THE INVENTION

There are many applications which require an integrated circuit which has a configurable interconnect network. One such application is a multi-processor environment for parallel computing, either on a single chip (or spanning multiple chips), where the interconnect network routes data between the processors depending on how the processors have been scheduled. Another application is the so-called System-on-a-Chip (SOC) where the connections between the processors, memories, and peripheral elements of an integrated circuit can be changed depending on the demands of the program that is running. Yet another application is a Field Programmable Gate Array (FPGA), either as a discrete chip or as a core on an SOC, where the elements to be interconnected are logic gates in varying degrees of complexity according to the design of the FPGA.

Currently, SRAM (Static Random Access Memory)-based FPGA products are often used for these applications. SRAM cells are used to hold the configuration bits to set the desired configuration of the interconnect network. An general example of the interconnect network architecture is illustrated by a cell unit illustrated in FIG. 1A. This basic array structure unit is repeated in two directions across an integrated circuit to form a mesh architecture for FPGAs of varying sizes. In this arrayed structure, connections are made between the switch cell 10 and its four neighboring switch cells 10 to the north, east, west, and south directions. The switch cells 10, connection cells 11, and all their wires (i.e., conducting lines of the integrated circuit) and connections constitute the interconnect network for the logic cells 12, which are formed by logic gates. The logic cells 12 are used to implement the actual circuit logic, the connection cells 11 are configured to connect the logic cells 12 to the interconnect network, and the switch cells 10 are configured to implement the desired interconnect network.

This traditional mesh architecture is described in greater detail in an article, “Flexibility of Interconnection Structures for Field Programmable Gate Arrays,” J. Rose and S. Brown, IEEE Journal of Solid-State Circuits, vol. 26, no. 3, March 1991, and in a data sheet, Virtex-E 1.8V Field Programmable Gate Arrays, from Xilinx Corporation of San Jose, Calif. A description of the current use of this FPGA architecture in industry practice is posted at the Xilinx company's webpage, http://www.xilinx.com/partinfo/ds022.pdf.

The flexibility of this traditional architecture lies within the connection cells 11 and the switch cells 10. To make the connections between conducting wires in these cells 10 and 11, each possible connection in the FPGA interconnect network has its own pass transistor and its controlling configuration bit (Config Bit) which is stored in a memory cell, as illustrated by the exemplary interconnect network of FIG. 1B. Four vertical wires 16 are crossed by two horizontal wires 17 and at each intersection that can be configured as a wire-to-wire connection, there is a pass transistor 15 controlled by a configuration bit . In this example, there are eight pass transistors 15 and eight configuration bits. Alternatively, instead of a pass transistor 15, a pass gate could be used.

However, this conventional configurable interconnect architecture and network has problems and disadvantages. Each pass transistor or pass gate requires a configuration bit, which requires a memory cell. As the interconnect network grows, the memory cells for the configuration bits occupy more space on the integrated circuit. Secondly, the conventional interconnect network has the possibility of electrical shorts to ground if the configuration bit are improperly set so that more than one wire drives a given wire. If one of the driving wires is power and the other is ground, the driven wire could be destroyed. This is an increasing possibility as silicon fabrication processes migrate to smaller geometries. Smaller geometries result in smaller noise immunity and in noisy operating environments, such as automotive applications, a configuration bit might swap states and create a catastrophic short. Unpredictable timing delays is another problem which is exacerbated by shrinking geometries. The conventional interconnect network has highly variable loading for any given wire, depending on how many wires it fans out to and how far through the mesh connections are made. As geometries shrink, this problem becomes a dominant issue in achieving timing closure for a design. Still another problem is worst case delays. In the traditional mesh network, the longest path is proportional to the square root of N, the number of cell units in the interconnect architectures. For example, in a square array of 4K core cells in an FPGA, the longest path in a mesh is 128. Hence timing becomes more of a problem as the interconnect becomes larger. Finally, the conventional interconnect network is not easily scalable. As the interconnect network becomes larger, the mesh architecture must expand every switch cell to accommodate the increased interconnection demands.

The present invention avoids or mitigates many of these problems. It provides for architectural regularity and is scalable and easily generated by software.

### SUMMARY OF THE INVENTION

The present invention provides for a configurable interconnect system on an integrated circuit, which has an array of conducting lines capable of being configured into a desired interconnect system by a plurality of multiplexers responsive to configuration bits. Each of the multiplexers has a plurality of input terminals connected to a subset of conducting lines and an output terminal connected to one of conducting lines. The multiplexer connects one of the input terminal conducting lines to the output terminal conducting line responsive to a subset of the configuration bits. Another aspect of the present invention is that the array of conducting lines and plurality of multiplexers are organized and arranged to form units in hierarchical levels, a plurality of units of one hierarchical level forming a unit in a next higher hierarchical level so that any pair of units in a hierarchical level having a configurable interconnection within a unit of the lowest hierarchical level unit containing the pair of units.

Another aspect of the present invention is that the configurable interconnect system is parametrically defined so that a software generator can easily create a desired configurable network. One parameter is the number of units of one hierarchical level forming a unit in a next higher hierarchical level.

### BRIEF DESCRIPTION OF THE DRAWINGS

FIG. 1A illustrate the typical configurable interconnect architecture of an FPGA; FIG. 1B illustrates an exemplary interconnect network for the FIG. 1A architecture.

FIG. 2 shows an exemplary multiplexer-based interconnect network, according to the present invention;

FIG. 3A illustrates the bottom level of a hierarchical multiplexer-based interconnect architecture according to one embodiment of the present invention; FIG. 3B shows the next higher level, or parent, of the FIG. 3A hierarchical level; FIG. 3C shows the next higher level, or parent, of the FIG. 3B hierarchical level;

FIG. 4A illustrates the input and output multiplexers of the two hierarchical levels of FIG. 3B; FIG. 4B shows how the multiplexers of FIG. 4 make a connection between two bottom level units;

FIG. 6A shows the connections of a bottom level core cell to its output multiplexers; FIG. 6B shows the connections of a bottom level core cell to its input multiplexers;

FIG. 7A illustrates the outward, or export, connections to one parent output multiplexer from the output multiplexers of all bottom level units forming the parent; FIG. 7B illustrates the outward, or export, connections from one output multiplexer of a bottom level unit to the output multiplexers of the parent unit; FIG. 7C illustrates the outward, or export, connections from the other output multiplexer of the bottom level unit highlighted in FIG. 7B to the parent output multiplexers;

FIG. 8 illustrates all the outward, or export, connections of all 16 bottom level units to the output multiplexers of the parent unit;

FIG. 9A illustrates the inward, or import, connections from one parent input multiplexer to the import multiplexers of all bottom level units forming the parent; FIG. 9B illustrates the inward, or import, connections to one input multiplexer of a bottom level unit from the input multiplexers of the parent unit;

FIG. 10 illustrates all the inward, or import, connections to all 16 bottom level core cells from the input multiplexers of the parent unit;

FIG. 11A illustrates the crossover connections of a input multiplexer of one 4-core cell child to the output multiplexers of the other 4-core cell children; FIG. 11B illustrates the connections of one output multiplexer of one 4-core cell child to the input multiplexers of the other 4-core cell children;

FIG. 12 illustrates all the crossover connections for the 16-core cell unit;

FIG. 13A shows the connections to one input multiplexer of a core cell from the output multiplexers of the three fellow core cells; FIG. 13B shows the connections from one output multiplexer of a core cell to the input multiplexers of the three fellow core cells;

FIG. 14 illustrates all the crossover connections of the 16 core cells; and

FIG. 15 is a layout of a multiplexer-based, hierarchical configurable interconnect network with the parameters described above and automatically generated in accordance with the present invention.

### DESCRIPTION OF THE SPECIFIC EMBODIMENTS

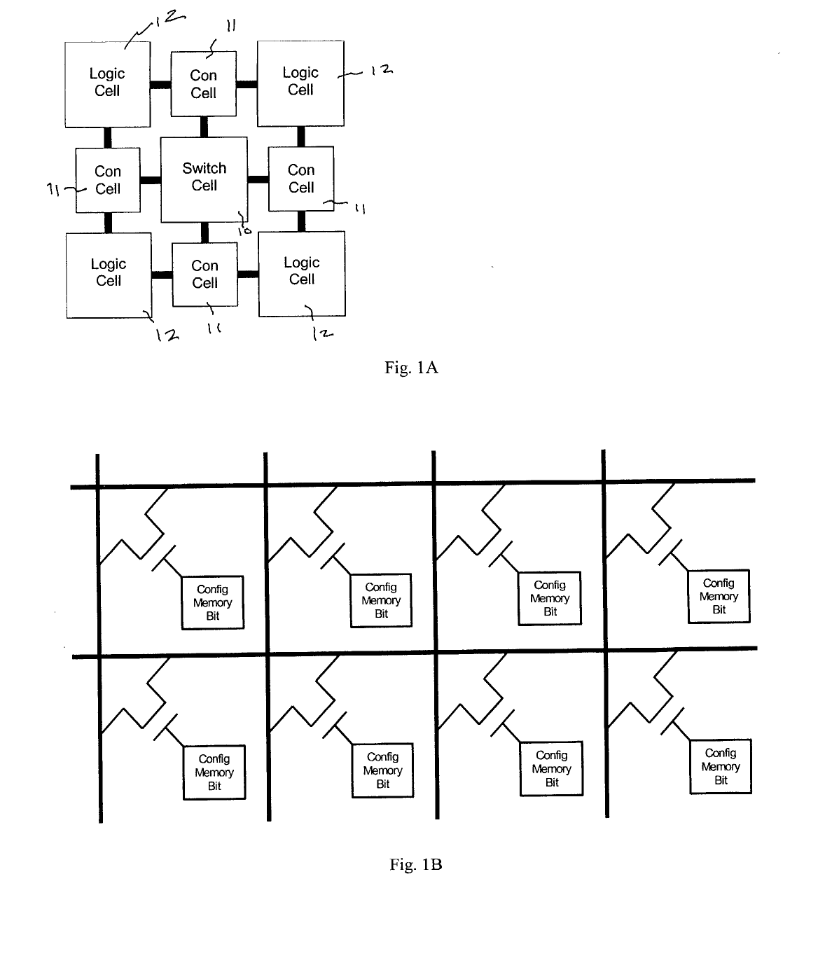

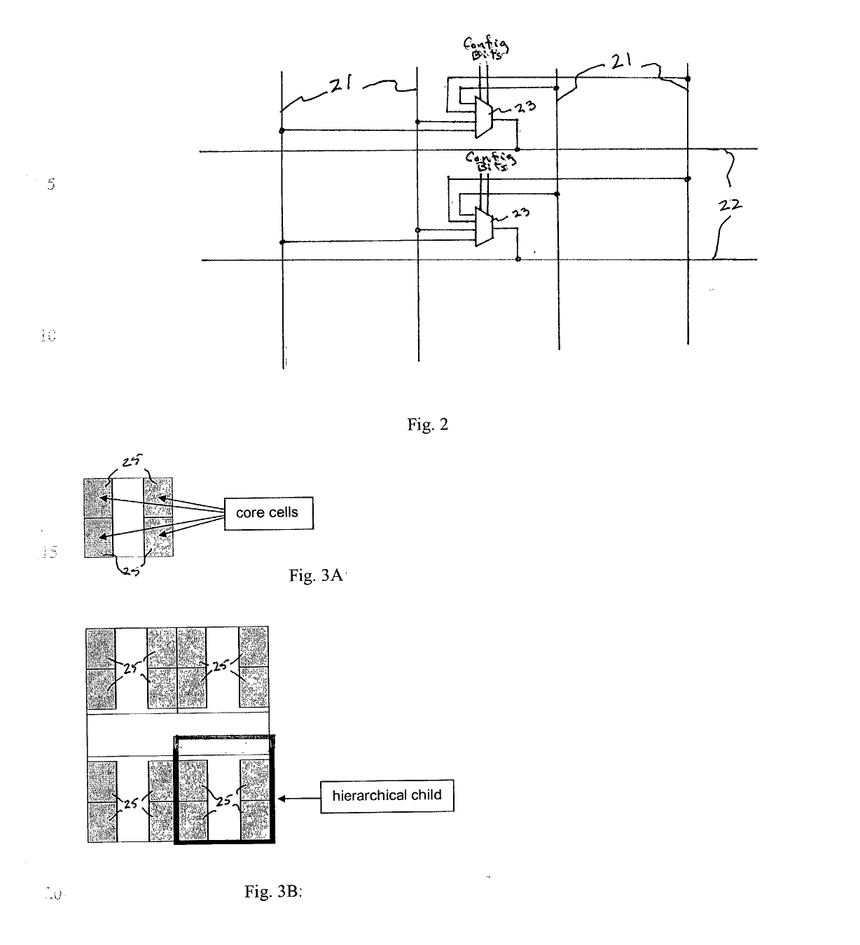

The present invention uses a hierarchical, multiplexer-based interconnect architecture. An example of a multiplexer-based interconnect network is shown in FIG. 2 in which four vertical wires 21 intersect two horizontal wires 22. Rather than pass transistors or pass gates, multiplexers 23 are used. In this example, each horizontal wire 22 is connected to the output terminal of a multiplexer 23 which has its input terminals connected to the vertical wires 22. Each horizontal wire 22 is driven by a 4:1 multiplexer 23 which is controlled by two control bits. In this simple example, only four configuration bits are required for the instead of eight in the case of the conventional configurable network of FIG. 1B.

Hence a multiplexer-based configurable interconnect network requires fewer configuration bits to implement the same switch cell in a configurable interconnect network. Fewer configuration bits implies smaller FPGA layouts, smaller external configuration memory storage, lower product cost, and faster configuration times. Another advantage of the pass transistor configurable interconnect network is that a multiplexer-based configurable interconnect network can not short power and ground.

The present invention also uses a hierarchical architecture with the multiplexer-based configurable interconnect network. This results in predictable signal timing because the output of a multiplexer at every level of the hierarchy has a tightly bounded load, even when the net being routed has high fanout. In contrast, the signal paths and the timing of the signals are often unpredictable in the conventional FPGA mesh network architecture described above. The hierarchical architecture of the present invention also has faster worst case delays. As described previously, the longest path in a traditional mesh network is proportional to the square root of N. In a hierarchical network, the longest path is proportional to log N, so that worst case delay grows much more slowly with increasing N for a hierarchical network. For example, in a square array of 4K core cells, the longest path in a conventional mesh would be 128, whereas in a hierarchical quad tree it is only be 12.

A hierarchical architecture has the advantages of scalability. As the number of logic cells in the network grows, the interconnection demand grows super-linearly. In a hierarchical network, only the higher levels of the hierarchy need to expand and the lower levels remain the same. In contrast, the mesh architecture must expand every switch cell to accommodate the increased demands. In addition, a hierarchical architecture permits the automatic generation of an interconnect architecture. This is a key capability for FPGA cores to be easily embedded within a user's SOC. An automatic software generator allow the user to specify any size FPGA core. This implies the use of uniform building blocks with an algorithmic assembly process for arbitrary network sizes with predictable timing.

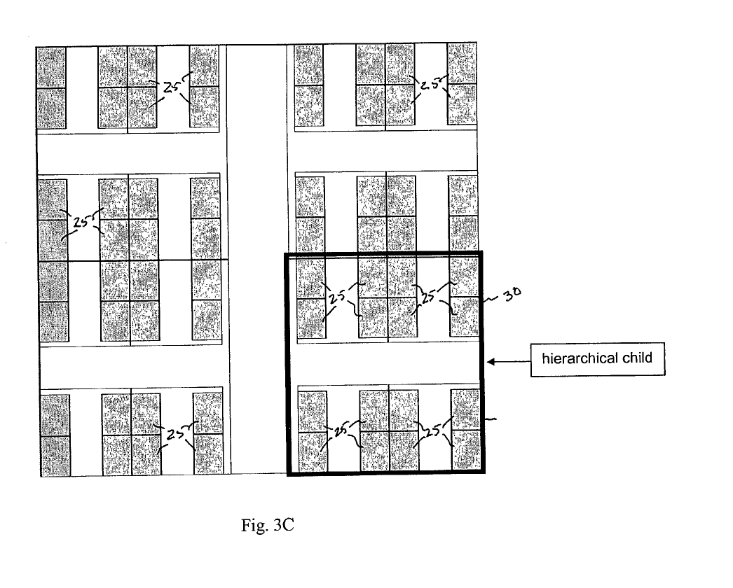

In the particular embodiment of the present invention, every level of the hierarchy is composed of 4 units, i.e., stated differently, every parent (unit of a higher level) is composed of four children (units of a lower level). The bottommost level is composed of 4 core cells, as illustrated in FIG. 3A. FIG. 3B shows how four bottom level units form a second hierarchy level unit and FIG. 3C shows how four second level hierarchy level units 30 form a third hierarchy level unit. Thus a third level unit is formed from 64 core cells. Of course, the number of children can be generalized and each level can have a different number of children in accordance with the present invention.

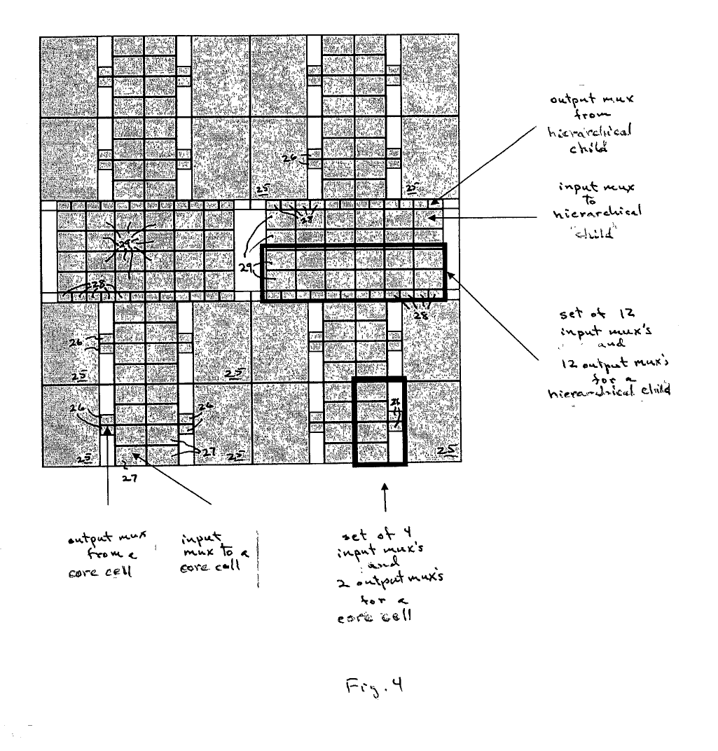

Every child at every level has a set of input multiplexers and a set of output multiplexers which provides input signal connections into the child unit and output signal connections out from the child, respectively. In the exemplary hierarchy shown in FIG. 4, a core cell 25 has four input multiplexers 26 and two output multiplexers 27, but the interconnect architecture can be generalized to any number of input multiplexers and output multiplexers. Four core cells 25 form a bottommost level which has a set of 12 input multiplexers 38 and 12 output multiplexers 29. Likewise, the next hierarchical level unit has a set of input multiplexers and a set of output multiplexers, and so on.

The pattern of connections for the multiplexers has three categories: export, crossover, import. These different categories are illustrated by FIG. 5 in an example connection route from a core cell A to a core cell B. There is an connection from an output multiplexer 26A of the core cell A to an output multiplexer 28A of the bottommost, hierarchical level 1, unit 30A holding the core cell A. Then there is a crossover connection from the output multiplexer 28A to an input multiplexer 29B of the level 1 unit 30B holding the core cell B. Units 30A and 30B are outlined by dotted lines. Finally, there is an import connection from the input multiplexer 29B to an input multiplexer 27B of the core cell B. It should be noted that the configured connections all lie within the lowest hierarchical level unit which contains both ends of the connection, i.e., the core cell A and core cell B. In this example, the lowest level unit is the level 2 unit which holds 16 core cells 25, including core cells A and B.

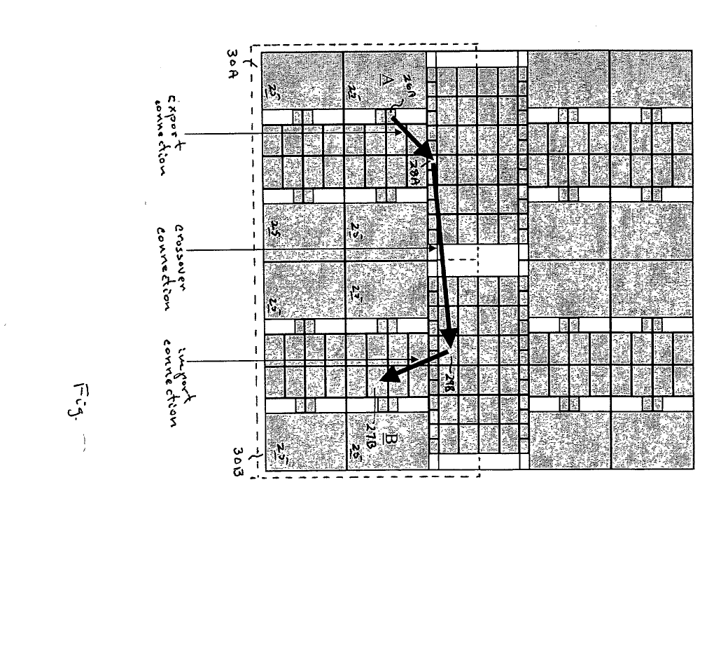

The complete set of connections for each multiplexer is described next. Starting with the core cells 25, each core cell 25 is connected to its input multiplexers 27 and output multiplexers 26. FIG. 6B illustrates how a core cell 25 is connected to each of its output multiplexers 26 and FIG. 6B illustrates how a core cell 25 is connected to each of its input multiplexers 27.

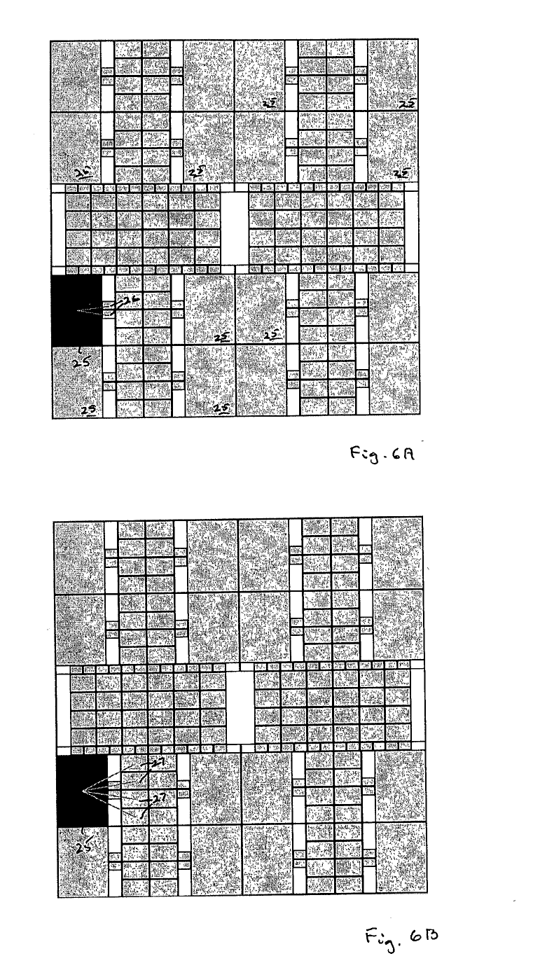

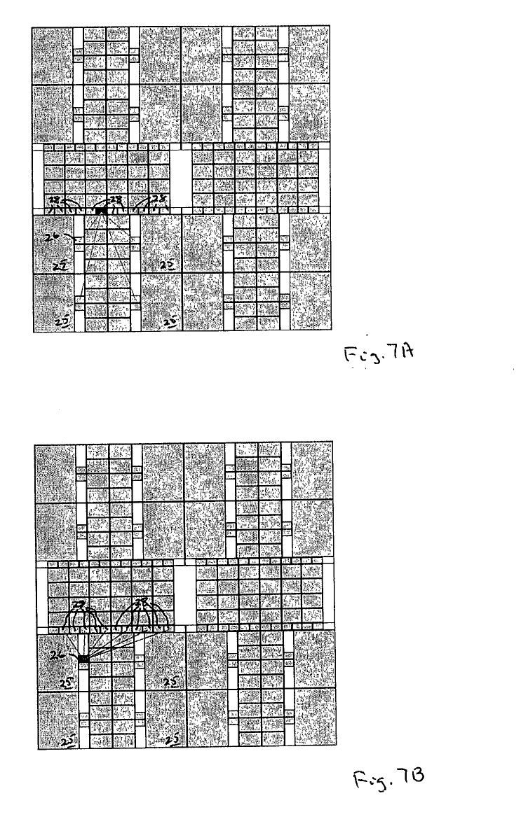

With respect to multiplexers of the hierarchical level units, the “parent” and “children”, each output multiplexer of a hierarchical parent is connected to an output multiplexer of each of its hierarchical children. The software generator evenly distributes the connections so as to maximize the potential routing paths from a given multiplexer and minimizes potential local congestion. For example, the “first” parent multiplexer is connected to the “first” child multiplexer, the “second” parent multiplexer is connected to the “second” child multiplexer, and so forth. If the number of output multiplexers belonging to the parent and to the children don't match, a function, such as an arithmetic modulo, is used to wrap around the connections. FIGS. 7A-7C and 8 illustrate export connections. FIG. 7A illustrates the connections of a level 1 unit output multiplexer 28 to the output multiplexers 26 of the core cells 25 forming the unit. Conversely, FIG. 7B illustrates the connections of a core cell output multiplexer 26 to the output multiplexers 28 of core cell's parent. FIG. 7C illustrates the connections of the second core cell output multiplexer 26 to the output multiplexers 28 of core cell's parent and the distribution of connections by the modulo function described previously. FIG. 8 illustrates all the export connections for the 16 core cells 25 of the level 2 unit.

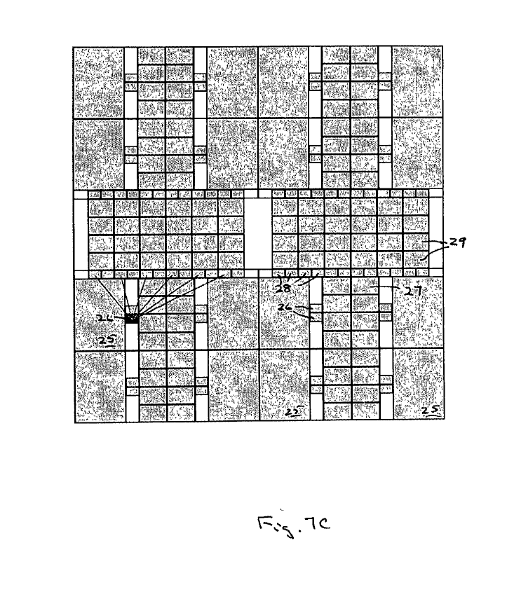

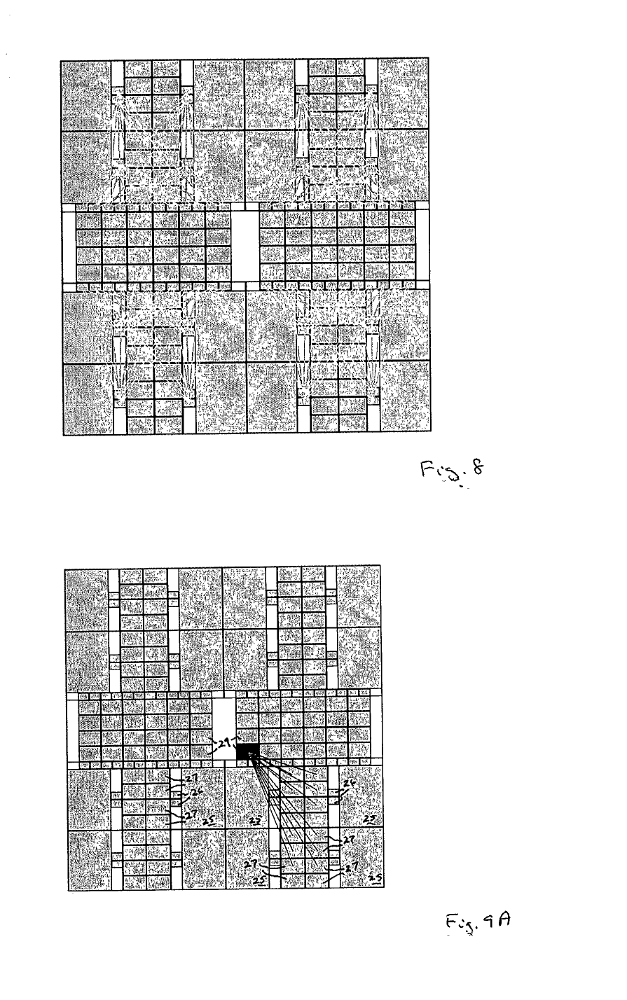

Similarly, each input multiplexer on a hierarchical parent is connected to the input multiplexers on each of its hierarchical children. If the number of input multiplexers on the parent and children don't match, a distributing function, such as arithmetic modulo is used to wrap around the connections. FIG. 9A shows the import connections from one input multiplexer 29 of a level 1 parent unit to the input multiplexers 27 of its four core cell children. Conversely, FIG. 9B shows the import connections to one core cell input multiplexer 27 from the import multiplexers 29 of its parent. FIG. 10 illustrates all the import connections for the 16 core cells 25 of the level 2 unit.

These import and export connections example illustrates another parameter of the interconnect architecture. The number of connections between a parent multiplexer and the multiplexes if its child can be specified. For the export connections described above, a parameter of 1 is used. In other words, each parent multiplexer was connected to one multiplexer on each child. For the import connections, a parameter of 3 is used. In other words, each parent input multiplexer is connected to three input multiplexers on each child. A distribution function, such as the described modulo function, is used to distribute the connections evenly.

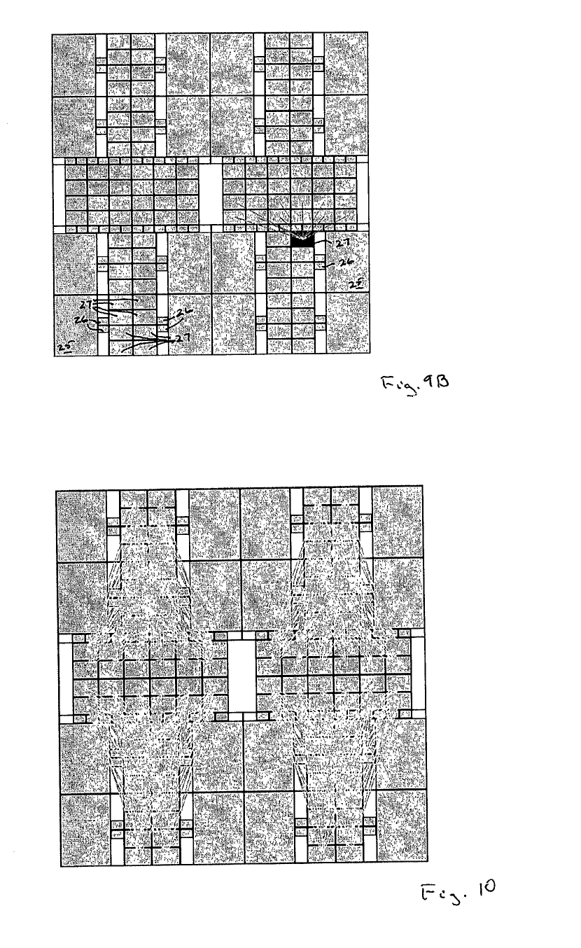

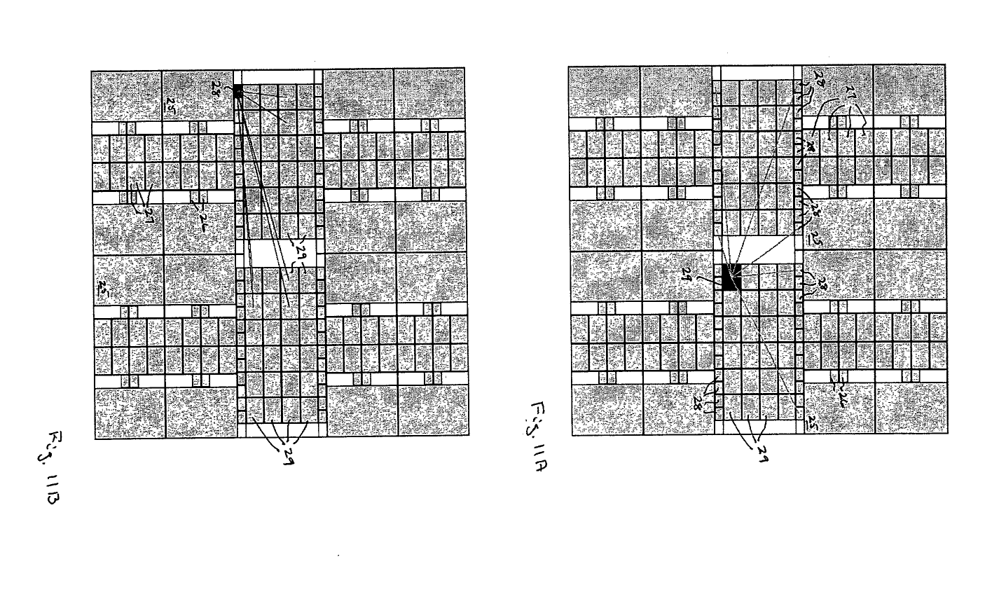

Crossover connections join the export to the import connections at each level of the hierarchy. At each level, there are generally the same number of output multiplexers and input multiplexers. For the crossover connections, each input multiplexer on each child is connected to the corresponding output multiplexer on each of the other children at the same hierarchy level. In this example where every level has 4 children, each input multiplexer then connects with the output multiplexers of 3 other children. There is also a parameter for the number of many output multiplexers to connect for each child and a function is used to evenly distribute the connections. In this example, a parameter of 2 was specified. This is illustrated in FIG. 11A in which a input multiplexer 29 of one 4-core cell child is connected to six output multiplexers 28 of the other 4-core cell children. Conversely, FIG. 11B illustrates the connections of one output multiplexer 28 of one 4-core cell child to six input multiplexers 29 of the other 4-core cell children. FIG. 12 illustrates all the crossover connections for the 16-core cell unit.

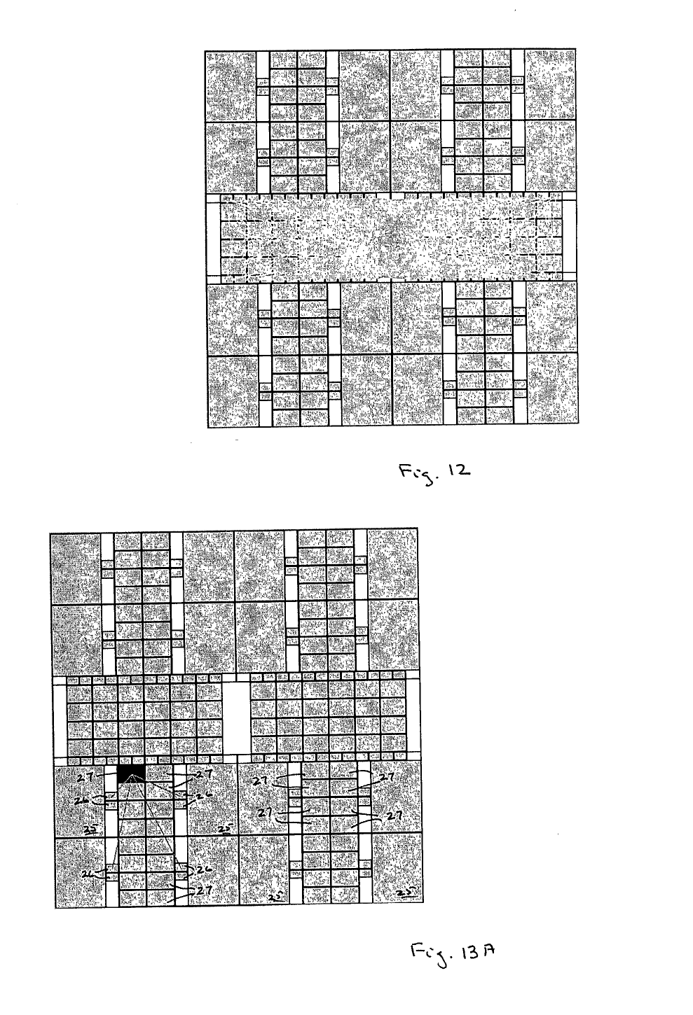

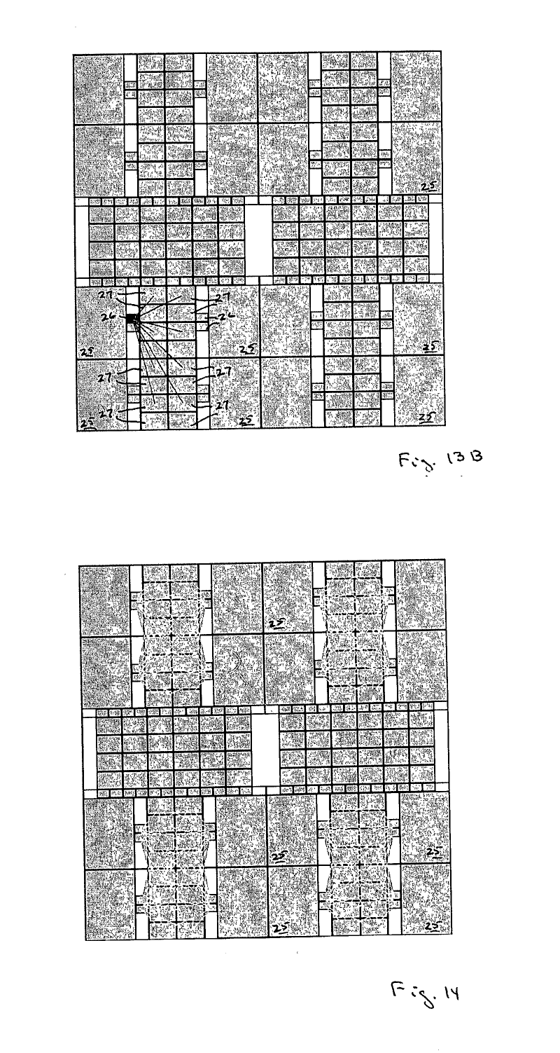

A special case of crossover connections are the bottommost core cell interconnections. At the level of the core cells 25, the input multiplexers 27 are connected to the output multiplexers 26 of all children, including itself, as shown in FIG. 13A. This accommodates feedback paths on a single core cell 25. In this example, the parameter for number of connections per child is specified as 1. FIG. 13B shows the connections from one output multiplexer 26 of a core cell 25 to the input multiplexers 27 of the three fellow core cells 25. Note there are two connections to the input multiplexers 27 of each core cell 25. FIG. 14 illustrates all the crossover connections of the 16 core cells.

The present invention takes advantage of the regularity and predictability of the hierarchical architecture by parameterizing the generation of the interconnect network. The input data can come from a file or interactive user inputs. Many of the characteristics of the desired configured network are described by parameters. The total number of logic cells is parameterized. In the described example, 16 core cells were specified. The number of children per hierarchy level is parameterized, in this example, 4 children at every level. The number of input and output multiplexers for each hierarchical level is parameterized. In this described example, a constant ratio of 3 for parent multiplexers versus child multiplexers was specified. In other words, if there are 4 input multiplexers for a unit at one level, then the parent level has 12 input multiplexers.

The following is an example of a possible specification in a file:

| | | | | | | | |
|---|---|---|---|---|---|---|---|
| levels | | | | | | | |
| level | 1 | children | 1 | imports | 4 | exports | 2 |
| level | 2 | children | 4 | imports | 12 | exports | 12 |
| level | 3 | children | 4 | imports | 36 | exports | 36 |
| level | 4 | children | 4 | imports | 108 | exports | 108 |
| level | 5 | children | 4 | imports | 216 | exports | 216 |
| level | 6 | children | 4 | imports | 432 | exports | 432 |
| level | 7 | children | 2 | imports | 864 | exports | 864 |
| endlevels | | | | | | | |

It should be noted that the constant ratio 3 was chosen based on a paper that empirically studied routability in hierarchical interconnects, i.e., “Routing Architectures for Hierarchical Field Programmable Gate Arrays,” A. Aggarwal and D. Lewis, Proceedings of IEEE International Conference on Computer Design, 1994. The paper concluded that a ratio of 1.7 in a binary tree hierarchy gave adequate routability. For a quad tree hierarchy, this would be (1.7*1.7)=2.89. Since the study only used relatively small examples, this ratio should be considered a minimum requirement. The constant 3 is approximately the same as Rent's Rule calculations using an exponent of 0.75.

The described interconnect architecture with the stated constants as parameters was also tested against dozens of industry standard benchmarks and real world designs. As many as 16K core cells were used and utilizations as high as 100% were obtained. All test cases were completed successfully. In particular, the stated parameters for a quad tree hierarchy of core cells with 4 inputs and 2 outputs was used, with each output multiplexer 4:1 and each input multiplexer 12:1, except for the core cell where each input multiplexer was 13:1. The propagation delays for multiplexers of these sizes and fanouts were very acceptable.

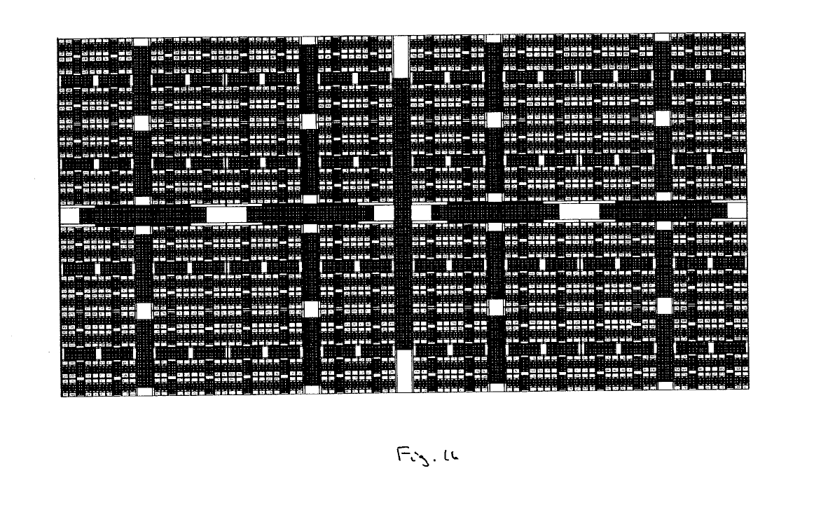

The uniformity of the multiplexer sizes and their interconnection pattern enables the easy automatic generation of this interconnect architecture. Beside the generation of the configurable interconnect network by the automatic software, the network is easily scalable for the most appropriate size. Timing delays are predictable and the worst case delays are known. FIG. 15 is the result of the software generator, a multiplexer-based hierarchical configurable interconnect network with 2048 core cells.

While the foregoing is a complete description of the embodiments of the invention, it should be evident that various modifications, alternatives and equivalents may be made and used. Accordingly, the above description should not be taken as limiting the scope of the invention which is defined by the metes and bounds of the appended claims.

What is claimed is:

1. A configurable interconnect system on an integrated circuit, comprising
an array of conducting lines capable of being configured into a desired interconnect system by a plurality of multiplexers responsive to configuration bits, each of said multiplexers having a plurality of input terminals connected to a subset of conducting lines and an output terminal connected to one of conducting lines, said multiplexer connecting one of said input terminal conducting lines to said output terminal conducting line responsive to a subset of said configuration bits.

2. The configurable interconnect system of claim 1 wherein said array of conducting lines and plurality of multiplexers are organized and arranged to form units in hierarchical levels, a plurality of units of one hierarchical level forming a unit in a next higher hierarchical level, any pair of units in a hierarchical level having a configurable interconnection therebetween within a unit of the lowest hierarchical level unit containing said pair of units.

3. The configurable interconnect system of claim 2 wherein each plurality of units of one hierarchical level forming a unit in a next higher hierarchical level is preselected.

4. The configurable interconnect system of claim 2 wherein each unit in each hierarchical level has input and output multiplexers, each input multiplexer having a plurality of input terminals connected to conducting lines external to said unit and an output terminal connected to a conducting line internal to said unit, and each output multiplexer having a plurality of input terminals connected to conducting lines internal to said unit and an output terminal connected to a conducting line external to said unit.

5. The configurable interconnect system of claim 4 wherein each plurality of input and output multiplexers of a unit at each hierarchical level is preselected.

6. The configurable interconnect system of claim 5 predetermined (finite) set of multiplexer building blocks?

7. The configurable interconnect system of claim 5 wherein input terminals of said input multiplexers of each unit of one hierarchical level are connected to output terminals of input multiplexers of units of a next higher hierarchical level formed by said units of said first hierarchical level, and said output terminals of said output multiplexers of each unit of said one hierarchical level are connected to input terminals of said output multiplexers of said units of said next higher hierarchical level formed by said units of said one hierarchical level.

8. The configurable interconnect system of claim 7 wherein an output terminal of each input multiplexer of a unit of said next higher hierarchical level is connected to input terminals of each input multiplexer of each unit forming said unit of said next higher hierarchical level.

9. The configurable interconnect system of claim 7 wherein an input terminal of each output multiplexer of a unit of said next higher hierarchical level is connected to an output terminal of each output multiplexer of each unit forming said unit of said next higher hierarchical level.

10. The configurable interconnect system of claim 7 wherein connections of said input terminals of said input multiplexers of each unit of one hierarchical level to output terminals of input multiplexers of units of a next higher hierarchical level formed by said units of said first hierarchical level, and connections of said output terminals of said output multiplexers of each unit of said one hierarchical level to input terminals of said output multiplexers of said units of said next higher hierarchical level formed by said units of said one hierarchical level, are determined algorithmically.

11. The configurable interconnect system of claim 10 wherein an output terminal of each input multiplexer of a unit of said next higher hierarchical level is connected to input terminals of a subset of input multiplexers of each unit forming said unit of said next higher hierarchical level, said subset of input multiplexers of all units forming said unit of said next higher hierarchical level is determined by modulo for all units .

12. The configurable interconnect system of claim 10 wherein an input terminal of each output multiplexer of a unit of said next higher hierarchical level is connected to an output terminal of each output multiplexer of each unit forming said unit of said next higher hierarchical level. and connections of said output terminals of said output multiplexers of each unit of said one hierarchical level to input terminals of said output multiplexers of said units of said next higher hierarchical level formed by said units of said one hierarchical level,

13. The configurable interconnect system of claim 1 wherein said integrated circuit comprises an FPGA.

14. The configurable interconnect system of claim 1 wherein said integrated circuit comprises an SOC.
